(19) United States
(12) Patent Application Publication
(10) Pub. No.: US 2011/0153421 A1
(43) Pub. Date: Jun. 23, 2011

(54) Context-Based Selection and Presentation of Social Networking System Content and Advertisements

(76) Inventors: Victor Novikov, (US); Aditya Agarwal, (US); Kent Schoen, (US); Jared Morgenstern, (US)

(21) Appl. No.: 12/645,482

(22) Filed: Dec. 23, 2009

(51) Int. Cl. G06Q 30/00; G06F 15/16; G06Q 99/00

(52) U.S. Cl. 705/14.52; 705/14.53; 709/204

(57) ABSTRACT

A social networking system uses information that it obtains from and about its users to select social networking content and advertising for presentation to users in a way that optimizes for one or more optimization goals. Example optimization goals include monetization, user sharing, user engagement, system growth, and user communication. The social networking system may select social networking content and advertising based on their relevance to a particular user. The selected social networking content and advertising may be related to each other to provide a more interesting display to the user. The selected social networking content and advertising may be presented in a supplemental portion of a display, and be selected based on their relatedness to content in the main portion of the display.

### BACKGROUND

This invention generally pertains to social networking, and more specifically to combining social networking system content and advertisements in a social networking environment.

Social networking systems enable users (including people, businesses, and other entities) to form connections and interact with other users. For example, a user may post a set of pictures to a profile associated with the user on a social networking system. Other users who have formed a connection with that user can then review the posted pictures by browsing that user's profile. Social networking systems also track the connections and interactions among the users to obtain useful information about the users. For example, a social networking system may infer a user's interest in a particular topic based on the user's interactions with objects related to that topic. With a robust set of information about its users, a social networking system can enable its users to communicate information more efficiently, such as by directing a user's communications to other users who are interested in that user or in the content of the communication. This information also allows the social networking system to select communications and advertisements that are better tailored to the users based on each user's particular interests.

Social networking systems allow users to communicate with one another using various communication tools (e.g., messaging tools like email and streams or feeds that receive users' posted content). These communications can be personal messages directed to a particular user, or they may be broader posts to a community of users. The communications may comprise various types of information, from simple text about a user's interest, activities, etc., to multimedia posts including photos, video, hyperlinks, etc., to notifications of events, pages, groups, etc. Anything that may be shared over the Internet may be part of these communications. These communications, as well as the connections among the users and their activities within and outside of the social networking system, may be used by the social networking system to offer more relevant information to users.

Social networking systems can incorporate various mechanisms that provide users with content that is most likely to be relevant to any particular user. For example, users may be categorized by one or more attributes, such as geographic location, employer, job type, age, music preferences, interests, activities within or outside of the social networking system, or any other information that may be relevant to a user's interests. This information can be used to customize or target information delivery so that information that might be of particular interest to a user can be communicated to that user or to a group of users with common attributes or categorizations. In this way, users of a social networking system receive content that is most likely to be relevant to the users based on the information that the social networking system knows or can infer about each user.

Another application of this capability is to advertising. Advertisers can leverage the social networking system's information to target ads to users whose interests best align with the products or services being offered. Other applications include, for example, user engagement and growth. Social networking systems may present customized content to users, including news stories about other users (both individuals and other entities) in the social networking system. These news stories encourage users to engage with the social networking system, interact with other users, and form connections. Although some tools exist for these purposes, social networking systems can benefit from better ways to leverage the information available to the systems to optimize for any desired result (or, optimization goal), such as growth, user engagement, revenue, sharing, or any other goal of an administrator of the social networking system.

Another problem facing providers of online content who provide advertisements with their content is “ad blindness.” Typically, a provider of online content designates a portion of a display for advertisements. For example, websites often have banner ads that always appear in the same location at the top of a web page. Users learn to ignore that portion of the web page, which greatly diminishes the effect of the advertising. Accordingly, content providers and advertisers would benefit from better mechanisms to direct users' attention to a portion of a display that includes advertisements, while still providing relevant content to users of an online system.

### SUMMARY

To present content that is more effective and relevant to users than traditional online content, a social networking system uses information that it obtains from and about its users. In particular, the social networking system uses this information to select social networking content and advertising for presentation to users in a way that optimizes for a particular optimization goal. The social networking system may be configured for one or more optimization goals, such as maximizing monetization, sharing, user engagement, system growth, communication, or any other goal of an administrator of the social networking system. The optimization goal may be altered at any time, and in real time, depending on the needs or priorities of the administrator of the system.

In one embodiment, a social networking system optimizes for an optimization goal by presenting a selected set of content items to a user in a display, for example, within a designated portion of the display. In the case of a social networking website, for example, a web page may include a main portion and a supplemental portion. Other types of displays may likewise include main content and supplemental portions. In the case of a social networking website, the supplemental portion may contain the selected set of content items, and the main portion may contain other content of the social networking website (e.g., a profile page of a user or group, an application that runs on the social networking system, or any other web page served by the social networking website).

The social networking system may select the content items according to various methods to achieve the optimization goal. In one embodiment, the display is populated with content items that are related to topics of interest to the user. The selected content may be tied to any interests or activities of the user discernible by the system. In this manner, the content items are made relevant to the user's interests or activities at that moment or over a designated period of time, thereby increasing the chances that the user will engage and interact with the content items.

The selected set of content items may include a combination of one or more advertisements and one or more social networking content items. A social networking content item may comprise content that is related to users, objects, activities, or functionalities of the social networking system. Examples of social networking content items include news stories, suggested connections or suggestions to perform other actions, media provided to or maintained by the social networking system (e.g., pictures or videos), status messages or links posted by users to the social networking system, events, groups, pages (e.g., representing an organization or commercial entity), and any other content provided by or accessible via the social networking system. The social networking content items may be provided by various sources within the social networking system, such as a store or a generator of media, news stories, suggested connections, etc. The advertisements may be selected according to any method, including various methods for targeting a relevant advertisement to the user.

In one embodiment, the goal may be to increase user engagement (e.g., by providing useful social networking content items to a user) as well as to maximize monetization (e.g., by presenting ads that a user is likely to click). In this embodiment, the social networking system may achieve both of these goals by selecting advertisements and social networking content items that are related to each other. By presenting related content items in the supplemental portion of the display, this supplemental portion is more coherent and thus more likely to receive the attention of a user. Moreover, if the display includes a mixture of advertising interspersed with social networking system content, a user is more likely to pay attention to and interact with the advertisements if they are related to the other social networking system content.

Accordingly, in one embodiment, one or more social networking content items are selected for a particular user, and then one or more advertisements are selected based at least in part on their relatedness to the selected social networking content items. The advertisements and social networking content items are then combined into a portion of the display (e.g., the supplemental portion), where the display may include other content from the social networking system (e.g., in a main portion). In another embodiment, one or more advertisements are selected for a particular user, and then one or more social networking content items are selected based at least in part on their relatedness to the selected advertisements. Selecting the advertisements of interest to the user and then selecting the social networking content items related to those advertisements may lead to a better result in some implementations. For example, a social networking system may have a larger number of potential social networking content items than advertisements that are relevant to a particular user. In such a case, selecting advertisements first may help the social networking system identify a better set of content items that are both relevant to the user and related to each other.

In another embodiment, the content items (including the advertisements and/or the social networking content items) are selected based on their relatedness to content in the main portion of the display. For example, in a social networking website, advertisements are selected for the supplemental portion based on the remaining portion of the web page that a user is currently viewing. The selected advertisements may also be tied to a page or display the user has visited recently, visited a designated number of times within a particular time frame, visited in proximity to visits to other displays or pages, visited the most in their browsing history, etc.

In one embodiment, the social networking system optimizes for multiple optimization goals, for example some combination of monetization, sharing, user engagement, system growth, communication, or any other goal of an administrator of the social networking system. The social networking system determines a value or score, for each optimization goal, associated with different types of social networking content items and/or advertisements. The social networking system may also determine a value for an advertisement based on an expected monetary value for presenting the advertisement to a particular user. When the system prepares a display for a particular user, the system selects one or more social content items and/or advertisements based on the scores for each optimization goal and a selection of optimization goals to maximize provided by the system administrator. The social networking system may also applies rules for the selection of advertisements and social networking content items, such as mandating a minimum number of advertisements or a minimum number of social networking content items of a certain types (e.g., at least one suggestion to add a connection). The selected advertisements and social networking content items are then added to a display of a user interface of the social networking system (e.g., in a supplemental portion thereof), which is then provided to the user.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is an event diagram illustrating a process for selecting content to provide on a display to a user, in accordance with an embodiment of the invention.

FIG. 2 is a network diagram of a system for providing content items to users of a social networking system, in accordance with an embodiment of the invention.

FIG. 3 is a block diagram of a social networking system, in accordance with an embodiment of the invention.

FIG. 4 is an interaction diagram of a process for selecting content items for display, in accordance with an embodiment of the invention.

FIG. 5 is a flow chart of a process for selecting content items based on other content items provided on a list/window, in accordance with an embodiment of the invention.

FIG. 6 is a flow chart of a process for selecting content items based on the content on a display requested by a user, in accordance with an embodiment of the invention.

FIG. 7 is an illustration of a portion of an example display from a social networking system showing content items displayed, in accordance with an embodiment of the invention.

FIG. 8 is an interaction diagram of a process for generating content items for display, in accordance with an embodiment of the invention.

FIG. 9 is an interaction diagram of a process for collecting and applying feedback in content item selection, in accordance with an embodiment of the invention.

FIG. 10 is an event diagram illustrating a process for mixing content types and selecting content items to provide on a display to a user, in accordance with an embodiment of the invention.

FIG. 11 is a block diagram of a social networking system, in accordance with an embodiment of the invention.

FIG. 12 illustrates an example table for scoring content types, in accordance with an embodiment of the invention.

FIG. 13 is an interaction diagram of the process for selecting content types/items, in accordance with an embodiment of the invention.

FIG. 14 is a flow chart of a process for offline and online selection of content types/items, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Social Networking System and Display

A social networking system offers its users the ability to communicate and interact with other users. As uses herein, a “user” includes any individual, group, thing or entity that can be represented in a social networking system or on the Internet. In use, users are connected with other users through a social networking system. In some cases, users can connect via a social networking website. As used herein, the term “connection” refers to any connection, association, or relationship between two users recognized by the social networking system. Connections may be added explicitly by a user, for example, the user selecting another user to connect with, or automatically created by the social networking system based on common characteristics of the users (e.g., users who are alumni of the same educational institution). Connections in social networking systems are usually mutual, but need not be. For example, if Sam and Nair both agree to be connected to each other in the social networking system, there is a mutual connection. Some embodiments of a social networking system allow connections to be one way. For example, Sam may choose to connect to a Nair, but Nair does not agree to form a mutual connection. In this case, Sam will be connected to Nair, but may be limited in his interactions with Nair or prevented from seeing information that Nair only makes available to mutual friends. Some embodiments of a social networking system may also connect users via one or more levels of connections or degrees of separation (e.g. connections of connections). It should also be noted that social networking systems may or may not require formal membership, so the term “connection” may refer to another member, but it may also refer to any other user interacting with or using a social networking system.

In addition to interactions with other users, the social networking system provides users with the ability to take actions on various types of items represented in the social networking system. These items may include networks (where “networks” here refers not to physical communication networks, but rather networks of people) to which users may belong, events or calendar entries in which a user might be interested, computer-based applications that a user may use, transactions that allow users to buy or sell items, and content posted by other users or advertisers with which users may interact. These are just a few examples of the items upon which a user may act in a social networking system, and many others are possible. Though many of the embodiments and examples provided below are directed to a social networking website, the invention described herein is not limited to a social networking website, but can include other environments involving social networking systems or other types of websites. For example, the social networking system could be implemented with an application that obtains information from the social networking system using, e.g., application programming interfaces (APIs) or other methods. Further, the terms “display” or “page” described below can include anything that can be displayed on a client device (described below), such as a web page on a social networking website, a graphical user interface display (GUI), information provided in a message, and so forth.

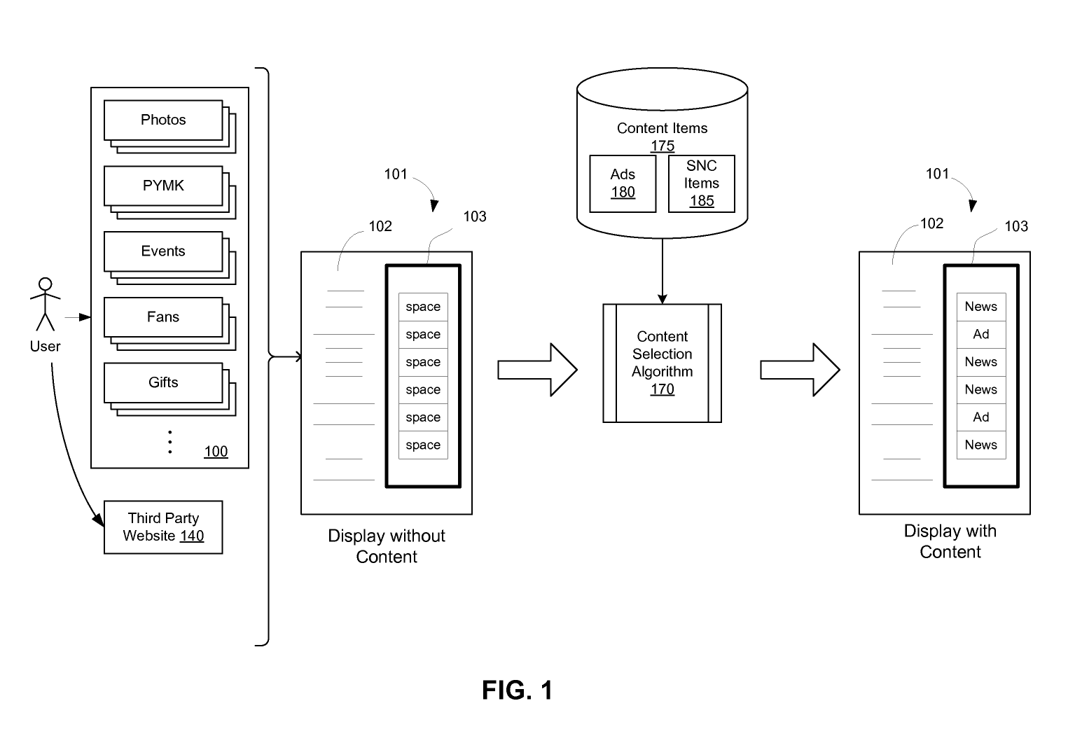

FIG. 1 illustrates an embodiment of the social networking system 100 with which the user can interact. In some embodiments, the social networking system 100 is associated with a social networking website. The social networking system 100 maintains information (e.g., web pages) for a number of users. The social networking system 100 of FIG. 1 illustrates some examples of content that can be available to users on these displays, including photos, people you may know (i.e., suggested connections), events, fans, gifts, videos, advertisements, applications, suggestions, requests, invitations, etc., which are described in more detail below.

An example of a display 101 is illustrated in FIG. 1. In some embodiments, such as the example shown in FIG. 1, the display 101 includes a main portion 102 and an information window 103. In other embodiments, the display 101 includes different and/or additional portions. The main portion 102 comprises a user interface for interaction with the social networking system or for accessing information about the social networking system, and the main portion typically includes the bulk of the content on the display. The information window 103 is a supplemental portion or area on the display 101 for presenting additional content (e.g., ads, news stories about connections, etc.), as described in more detail below.

In one example, each user has a page that presents profile information for that user, the content of which is commonly found in the main portion 102 of the display (though can be located elsewhere on the display 101). The profile may identify connections of the user to other users of the social networking system (e.g., the user's connections). A user's profile can include various types of content associated with the user, including personal information about himself, his likes and dislikes, photos, his list of connections, messages/comments between the user and other users, etc. Other users may then access and view a user's profile page to learn about and interact with that user.

A user may also view a display 101 that includes a newsfeed that provides information that may be relevant to that particular user. The newsfeed would commonly be found in the main portion 102 of display 101, though it can be located elsewhere on the display 101. Newsfeed communications may take the form of news stories, with each story having an informational message comprising one or more lines of information about a connection or other items represented in the social networking system that might be of interest to the particular user. These stories may also contain multimedia or other material, such as a photo, video, song, link, etc. Stories can be presented to a user via one or more displays or pages (e.g., web pages of a social networking website), for example in each user's home page or newsfeed page. In addition to being able to view his own pages, a user may also be able to view pages of his connections (privacy settings permitting) to see the connection's profile, photos, and/or other information associated with the connection. Actions that a particular user takes with respect to another user may be associated with that user's pages/profile (and may become the subject of a news story). For example, a user can add a connection to another user, send a message to another user, read a message from another user, view content associated with another user, and attend an event posted by another user, among others.

When a user is viewing a page in the social networking system, the user may be presented with various types of additional content about the user, the user's connections, or other content that may be of interest to the user. The user typically can interact with or select a link associated with some or all of this additional content. In one embodiment, the additional content is shown in a supplemental portion of a display or in an information window 103 that can be located somewhere on the display 101 that is distinguishable from the main content on the page. In the embodiments of the invention described below, the information window 103 refers to a portion of a display that contains content items, and that is in some manner distinguishable from the remaining content on the display (e.g., sometimes referred to here as the main portion 102 of the display 101). The information window 103 might be located over to one side of the display 101, at the top or bottom of the display 101 (e.g., like a banner ad), in the corner of the display 101, in the center of the display 101 (yet distinct from the main portion), as another tab or page associated with the main portion 102, or other locations that provide access to the additional content items. In other embodiments, the information window 103 may be static, clickable, or dynamic, such as a pop-up or scrolling ticker. In the example shown in IFG. 1, there are six available spaces for content items in the information window 103, but there can be more or fewer spaces, as desired. The number of available spaces does not have to be predetermined, nor does it have to be the same for each display 101. The content items described herein need not be displayed in an information window 103, but can be displayed or described in some other listing of content items on the display 101 or can even be interspersed with or included with content on the rest of the display 101.

In one embodiment, the information window 103 includes at least two kinds of content items: advertisements and social networking content items. Advertisements presented in the information window 103 are typically (but need not be) paid or sponsored advertisements. A social networking content item may comprise content that is related to users, objects, activities, or functionalities of the social networking system. Examples of social networking content items include news stories, suggested connections or suggestions to perform other actions, media provided to or maintained by the social networking system (e.g., pictures or videos), status messages or links posted by users to the social networking system, events, groups, pages (e.g., representing an organization or commercial entity), and any other content provided by or accessible via the social networking system. In this way, a social networking content item may present a user with content or highlights about what the user's connections are doing, or the social networking content item may notify the user that one of the user's connections posted new photos, commented on something, formed a connection with another user, or otherwise took an action that could be of interest to the user.

The social networking content items may also include messages or suggestions from the social networking system 100 to the user. For example, the content might include a “People you may Know” (PYMK) suggestion, which includes a suggestion to the user to add a particular other user as a new connection, as well as a link enabling the user to do so (e.g., “You may know Greg Griffin. Click here to add Greg as a friend”). A social networking content item might also suggest that the user invite new users who have not yet created a profile and are not already users of the social networking system. Further, a social networking content item may inform the user of events in which a user can participate (e.g., a friend's birthday party), applications that the user can use (e.g., an enhanced messaging service application in which users can send virtual gifts/flowers plus messages to others), groups that a user may join (e.g., a group supporting a political cause), gifts that a user can give (e.g., birthday gift), fan pages that a user can join (e.g. for bands, products, services, etc.), photos, videos, messages, and other items that may be interesting to the user. These examples of social networking content items are provided for illustration purposes only, and it can be appreciated that an unlimited number of variations and features can be provided for the social networking system.

A content selection algorithm 170, which may be executed by the social networking system, determines the appropriate content items to include in the available spaces of the window 103. A database of content items 175 provides the content item used by the content selection algorithm 170, the database 175 including both ads 180 and social networking content items 185. The content selection algorithm 170 selects the content to present to the user from the store 175 of content items in a manner that will optimize for any desired result, or optimization goal, such as growth, user engagement, revenue, sharing, or any other goal of an administrator of the social networking system.

In one embodiment, the user may be presented with the information window 103 on a third party website 140 or on some other display that is outside of the social networking environment or otherwise separate from the social networking system 100. The social networking system may thus syndicate this information window 103 (and the content items therein) on a third-party website 140 and/or through other external systems. Syndication of the social networking system's content items on external systems may comprise a social network communicating the content items to one or more external systems, which then present the content items to a user of the external system, who need not be a user of the social networking system. The communications between the social networking system and the external system that enables this syndication may be implemented in various ways, and one technique of implementing communication between a social networking system and an external system for this purpose is described in U.S. application Ser. No. 12/324,761, filed Nov. 26, 2008, incorporated by reference herein. Information from external systems (such as third party websites 140) can also be used to provide information to the social networking system 100.

### Social Networking System Architecture

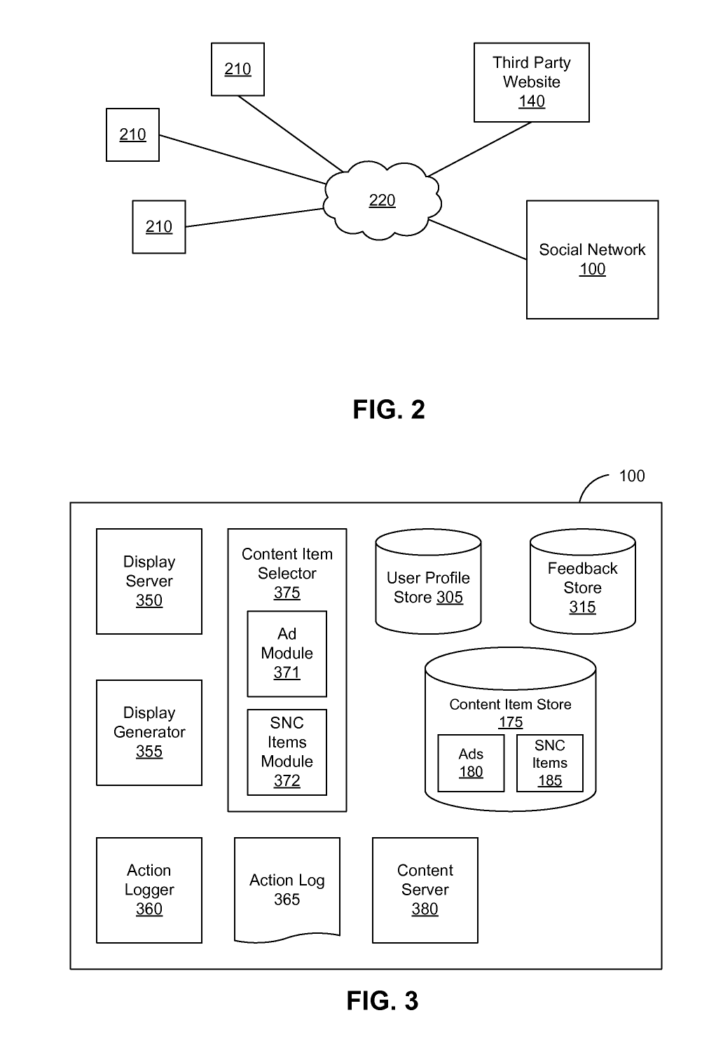

FIG. 2 is a high level block diagram illustrating a system environment suitable for operation of a social networking system 100. The system environment comprises one or more client devices 210, one or more third-party websites 140, a social networking system 100, and a network 220. In alternative configurations, different and/or additional modules can be included in the system.

The client devices 210 comprise one or more computing devices that can receive user input and can transmit and receive data via the network 220. For example, the client devices 210 may be desktop computers, laptop computers, smart phones, personal digital assistants (PDAs), or any other device including computing functionality and data communication capabilities. The client devices 220 are configured to communicate via network 220, which may comprise any combination of local area and/or wide area networks, using both wired and wireless communication systems. As described above, a third party website 140 may be coupled to the network 220 for communicating with the social networking system 100 about things that occur outside of the system 100.

The social networking system 100 comprises a computing system that allows users to communicate or otherwise interact with each other and access content as described herein. The social networking system 100 stores user profiles that describe users of the social networking system, which can include biographic, demographic, and other types of descriptive information, such as work experience, educational history, hobbies or preferences, location, and any other information about the user. The system 100 further stores data describing one or more connections, associations, and/or relationships between system users or information. This information may indicate, among other things, users who have similar or common work experience, group memberships, hobbies, or educational history. Additionally, the social networking system includes user-defined relationships between different users, allowing users to specify their relationships with other users. For example, these user-defined relationships allow users to generate relationships with other users that parallel the users' real-life relationships, such as friends, family, co-workers and so forth. Users may select from predefined types of relationships, or define their own relationship types as needed.

FIG. 3 is an example block diagram of a social networking system 100. The social networking system 100 includes a display server 350, a display generator 355, an action logger 360, an action log 365, a content item selector 375 (with an ad module 371 and a social networking content item module 372), a content server 380, a user profile store 305, a feedback store 315, and a content item store 175 (with ads 180 and social networking content items 185). In other embodiments, the social networking system 100 may include additional, fewer, or different modules for various applications.

The display server 350 links the social networking system 100 via the network 220 to one or more client devices 210, as well as to one or more third party websites 140 or other information sources. The display server 350 may include a mail server or other messaging functionality for receiving and routing messages between the social networking system 100 and the client devices 210 or third party websites 140 or information sources. The messages can be instant messages, queued messages (e.g., email), text and SMS messages, or any other suitable messaging technique. The display server 350 maintains information or pages associated with the social networking system for a number of users, as explained above. In one embodiment, each page/display 101 includes a main portion 102 and an information window 103, though different designs are also possible. The social networking system, or an external system outside of the social networking system, may maintain profiles for users of a social networking system, which include connections to other users of the social networking system. The profiles are stored in the user profile store 305.

The display server 350 also determines when a user of the social networking system has requested information to be rendered and receives this information request. For example, the user may have navigated to the user's own profile page, or the profile page of another user, and the display server 350 determines that the corresponding profile web page has been requested by the user. The display server 350 passes this information to the display generator 355 for generating the display for the user. The display generator 355 generates the requested information in the form of a display/page 101. As explained above, the display can be a web page or could be other information provided on a client device 210. The display generator 355 may notify the content item selector 375 when a display has been generated in response to a request from the user.

The content item selector 375 selects content items to be included in the information window 103 of the display 101. In one embodiment, the selector 375 selects a combination of advertisements and social networking content items. Specifically, the content item selector 375 includes an ad module 371 for selecting advertisements and a social networking content item module 372 for selecting social networking content items. The selected advertisements and social networking content items are then added to the information window 103 of the display generated by the display generator 355.

The content item selector 375 may use a content selection algorithm 170, shown in FIG. 1, for selecting what additional content to include on the display 101 (e.g., in the information window 103) to optimize for a desired result, or optimization goal. Various algorithms for optimizing are described in the following sections. For example, in selecting the content items to include in the information window 103, the selector 375 may consider other content items that have been selected or are available for selection for the information window 103. The selector 375 may also consider the content of the other portion of the display 101, such as the main portion 102. For example, the selector 375 can select advertisements to be included in the window 103 from a group of advertisements (e.g., stored in content item store 175) based on the selected advertisement being related to one or more of the social networking content items to be included in the window 103 and/or based on the content of the main portion 102 of the display 101. In this way, the advertisements presented to the user may be more relevant to the user's current interests (e.g., using the other content on the display 101 as a proxy for the user's current interests), thereby making the advertising more effective. It can be appreciated that a number of other strategies may be employed, several of which are described below.

For example, a news story that includes a photo from a connection's recent trip to Egypt may be one of the social networking content items that has been selected for the information window 103 for a particular user. The selector 375 may then select an ad related to a trip to Egypt (e.g., a vacation package to Egypt, airfare deals, a tour book on Egypt, etc.) to be displayed in the information window 103 along with the news story. Similarly, the selector 375 can choose a news story or other content to display based their relationship to advertisements selected for display window 103. For example, when an ad about vacation packages to Las Vegas is selected, the selector 375 can select news stories or other content that provide photos/videos/information related to a connection's recent Vegas trip. In both of these embodiments, the ads, news stories and/or other content are paired together to optimize for a particular result. In this case, the optimization goal might be to encourage users to interact with advertisements in the display window 103.

A content item that is selected based on its relatedness to another content item can be “related” in any sense of the word. For example, a content item can be related to the same topic or subject (e.g., both are about Egypt travel). A content item can be in the same category of information (e.g., both relate to cooking, such as an advertisement about a cooking class and a news story about a connection's cooking), where the social networking system stores a classification or other meta data associated with the content item. A content item may also be an advertisement related to an action performed by a user's connection, as reported in a news story (e.g., a news story about a connection becoming a fan of a book and an ad for that book), or a content item may be an advertisement related to an action performed by one user related to another user (e.g., a news story about a user wishing his connection a happy birthday coupled with an advertisement for birthday cards). Moreover, a content item can be an advertisement or a social networking content item related to other types of content, such as user comments, photos, videos, etc. (e.g. an advertisement for a surf travel service when a user posts photos of surfboards). A variety of other examples are also possible. Any way in which one piece of content can be related to another can form a basis for those pieces of content being displayed together.

In one embodiment, the selector 370 selects content items for the information window 103 based on the availability of a related content item to display with that content. For example, if there is a news story indicating that a user's connection became a fan of a product, such as a particular brand of shoes, the selector 370 can select an ad for that brand of shoes to include in the information window 103 instead of providing another ad that it might have otherwise selected related to a different product. Similarly, the selector 370 can select a news story about a user who went to a new restaurant to show alongside an ad for that restaurant, as opposed to an unrelated news story about another connection.

In some embodiments, the content item selector 370 varies the content items selected for the display (e.g., in the information window 103 or elsewhere) based on feedback received from the feedback store 315. In one case, the feedback store 315 can include explicit feedback provided by the user rating content items displayed in the information window 103 (or elsewhere in the display 101). For example, the user can provide a rating (e.g., a thumbs up or down, a one to five star rating, a point scale rating, or other indication of the user's preferences regarding content items) when viewing the content items. The user might indicate that he did not find interesting the ad that was paired with a related news story in the information window 103. The selector 370 can use this feedback in the future for providing better, more relevant content items to that user (e.g., content items on a different subject, content items that are more closely related, content items that are related in the different way, etc.). In on embodiment the user may be permitted to view and rate content items that were displayed over a particular period of time (e.g. in the last day, week, month, etc.). The feedback store 315 may also (or as an alternative) collect implicit feedback provided by the user based on engagement with the content items (e.g. by determining which content items or categories of items a user clicks on, shares with other users, comments on, spends the most time viewing, etc.). The selector 370 can use this feedback in selecting future items. The overall content selection process is described in more detail below.

The content server 380 detects the contents of the display generated by the display generator 355, and provides selected content items (chosen by the selector 370) for inclusion on the display. The content server 380 can then provide the complete display with all content items to the display server 350.

In one embodiment, the content server 380 also determines how to organize and present the news stories/ads in the information window and/or on the display. In this embodiment, the content server 380 can control the ordering or placement of ads/news items on the display. For example, the content server 380 can place the most relevant items at the top of a list of content items, can order the items in the information window 103 according to ordering on the main portion 102 of the display 101, can intersperse ads and news items and other content items, etc. Similarly, the content server 380 might present the most relevant content as soon as the user logs onto his account, or may save the more relevant content until after the user has been logged on for a while. For example, if the user typically does not click on ads until after he has been logged onto his account for a while, the content selector 375 may save the ads for later displays requested.

The display server 350 provides the display to the user. The display includes the content items (e.g., in an information window 103) selected by the content item selector 370 (e.g., news stories or ads). In the case of a social networking website, the display server 350 may comprise a web server.

In some embodiments, an action logger 360 is capable of receiving communications from the display server 350 about user actions on and/or off the social networking system 100. The action logger 360 populates the action log 365 with information about these tracked user actions. There are various different types of actions that can be logged by logger 360. As explained above, the users can interact with other users of the same social networking system (e.g., by sending messages, sending gifts, sending invitations to events, etc.). In addition to interactions with other users, the social networking system provides users with the ability to take actions on various types of content items (e.g., by commenting on news stories or other content items, sharing content items. signifying they like a particular item, etc.). Users may also join groups, become fans of pages dedicated to products, services, entities, and other things, create events, authorize and use applications that provide all manner of functionality and entertainment, engage in transactions that allow users to buy or sell items, visit hubs representing general concepts, etc. In some embodiments, the social networking system 100 maintains a number of objects for the different kinds of items with which a user may interact on the system 100 (e.g., such as user profiles, pages, hubs, group objects, event objects, application objects, transaction objects, etc.) where the objects can be stored by the system 100 for each instance of its associated item. These are just a few examples of the items upon which a user may act in a social networking system, and many others are possible.

When a user takes any of these types of actions or other actions, the action is recorded in the action log 365 (e.g., a database of entries in which an entry is added for each action). The social networking system 100 can also log actions that a user takes on a third party website 140. The system 100 may learn of the user's actions on the third party website 140 when the website 140 sends a message to the system 100 with a notification of the action through an API or otherwise (e.g., a notification that the user purchased an item on website 140). In another embodiment, the social networking system 100 logs actions taken by its users in the real world. For example, the user can register a credit card with system 100 so that when it is used in a qualifying way, a message is sent to system 100 via email, SMS, or any other appropriate means.

The action log 365 over time will become populated with entries related to activities of users of the social networking system 100. The action log 365 may therefore contain a very rich set of data about the actions of the users, and can be analyzed and filtered to identify trends and relationships, as well as affinities, between the users and various objects. The action log 365 can be used for many purposes. Each user's experience on the social networking system can be customized using data form the action log 365. This data can also be used by the system 100 to choose content items that more effectively optimize for a desired result, or optimization goal. The action log 365 can also track actions of users that can be stored by the feedback store 315, by tracking how users interact with and rate content items, etc.

Though the description provides many examples of a social networking website embodiment, embodiments of the invention are not limited to website embodiments. For example, in another embodiment, the social networking system is implemented on an application running on a client device 210 (e.g., a portable communications device) that accesses information from the social networking system using APIs or other communication mechanisms other than the Internet or web. Similarly, various other implementations for the social networking system are also possible.

### Process for Selecting Content Items

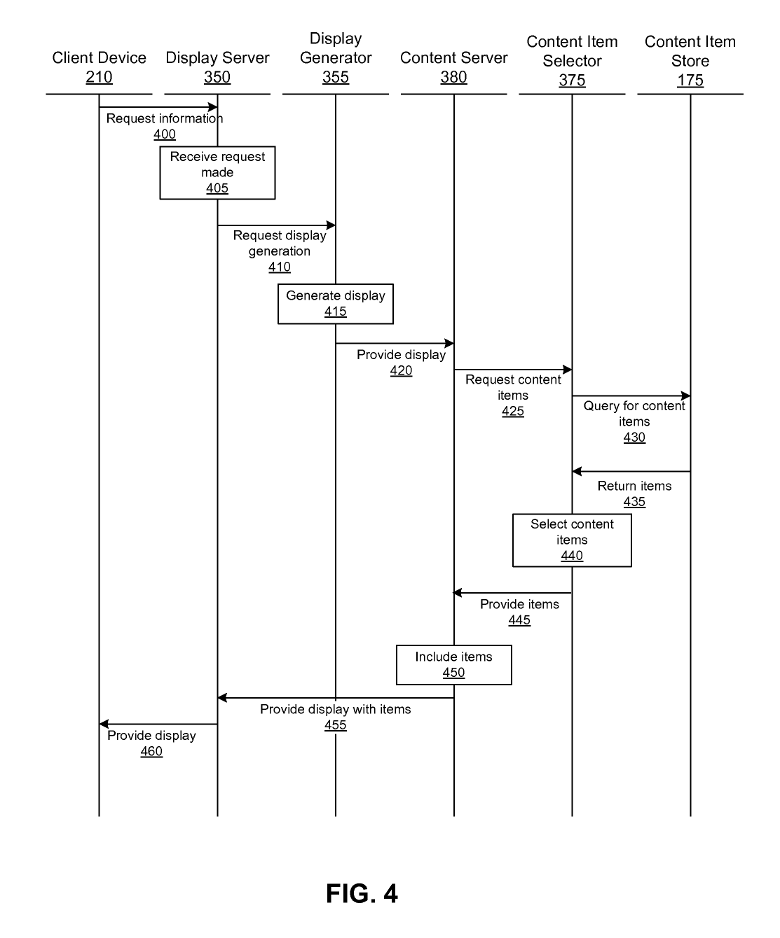

FIG. 4 illustrates a process for selecting content items, in one embodiment. In this process, a user requests 400 a page using a client device 210. The display server 350 receives 405 the request for information from the user of the social networking system and sends 410 a request to the display generator 355. The display generator 355 generates 415 the display, in response to the request. The display may include an information window 103 having available spaces in which to include content items and a main portion 102 that having a user interface for the social networking system, which may contain a profile page, a newsfeed, photos, pages, groups, events, applications, etc.

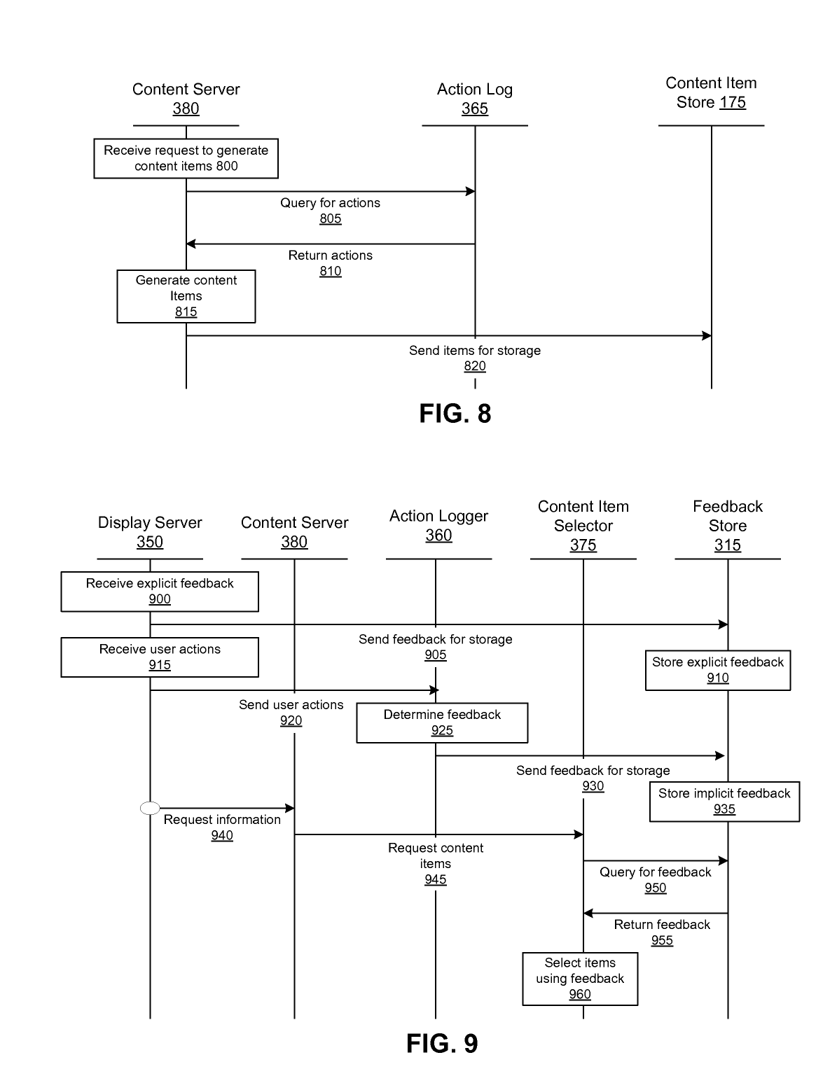

The display generator 355 provides 420 the display to the content server 380, which then requests 425 content items from the content item selector 375. The selector 375 selects 440 content items to include in the information window of the display. In one embodiment, the content item selector 375 first queries 430 the content item store 175 for content items (e.g., social networking content items, advertisements, etc.). The content item store 175 returns 435 content items that are available for providing to the user. For example, the content item store 175 may provide news stories or other social networking content items that relate to the user or one of the user's connections. In some embodiments, these different content items for a given user are generated in advance and then stored by the content item store 175 for later usage when the user logs on and requests information. In other embodiments, the content items can be generated dynamically, when a user requests 400 information. In either case, the items can be generated by content server 380, as explained in more detail in FIG. 8.

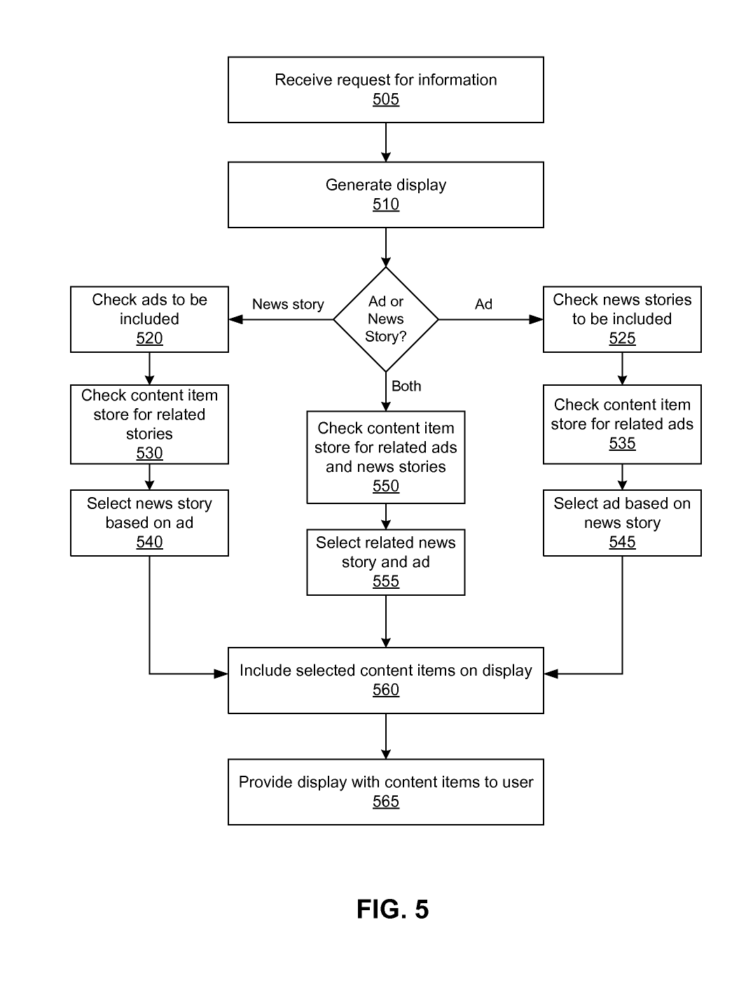

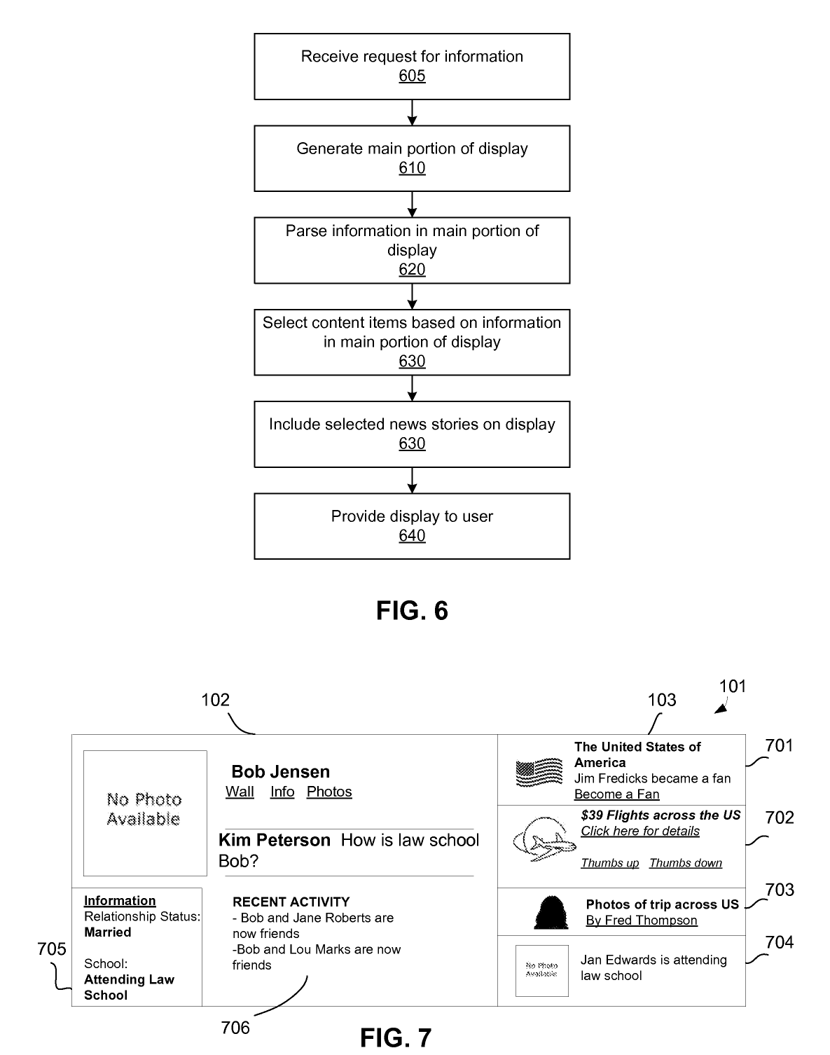

The content item selector 375 may use various content selection algorithms 170 to select 440 the content items to be included on the display generated 415 out of the group of available items from content item store 175. The algorithm used will depend upon the result that is being optimized for (i.e. growth, user engagement, revenue, sharing, etc.). The selector 375 may select the content items based on their relationship to other items that will be on the display, based on their relationship to other items that will be included in the information window 103, a combination of both. The selector 375 may also select the content items based on other factors related to the user's express or demonstrated interests, such as interest demonstrated by content viewed recently, viewed a designated number of times within a particular time frame, viewed in proximity to viewing other displays or content, viewed the most in the user's browsing history, or any other discernable activities or habits. The selection process is described in more detail in FIGS. 5 and 6. In some embodiments, the selector 375 provides 445 the items to the content server 380, which then includes 450 the selected items on the display. The content server 380 provides 455 the display with the selected items to the display server 350, which then provides 460 the display plus content items to the user on the client device 210.

### Selecting Content Items Based on Related Content Items in Information Window

FIG. 5 illustrates an embodiment of a content item selection process, in which content items are selected based on their relatedness to other content items selected for the information window. In this embodiment, the social networking system receives 505 a request from a user for information, and the social networking system begins the process of generating 510 a display responsive to the request, such as in the process described in FIG. 4. The display to be generated includes a set of spaces available in an information window for a set of content items. Accordingly, the social networking system selects content items to fill the available spaces in the information window 103.

As described above, the content item selector 375 of the social networking system may determine what type of content items to add (e.g., an advertisement, a news story, a photo, a video, or other content items). The content item selector 375 may determine what type of content items to add to the information window based on a set of predetermined rules (e.g., at least three ads and one suggested connection), how many open spaces there are to fill, what other content is in the display, etc. For example, if the information window will have three ads, and has two remaining openings for content items, the social networking system might select two news stories to balance out the content items in the window. How these spaces are populated may depend largely upon what optimization goal is being optimized for by the system. The content item selector 375 may select just enough content items to fill the open spaces on a display, or the content item selector 375 may select more items than can be presented on one display (e.g., items for multiple displays for the user).

In one example, once one or more content items are selected, the content item selector 375 selects additional content items from a group of available content items. Content items may be available based on their existence as well as their eligibility to be presented to a user. For example, the social networking system may enforce a privacy rule that dictates whether a user can see a news story, so the news story is an available content items for a display to be shown to that user only if the privacy setting allows it. The example shown in FIG. 5 refers to news stories, but it can be appreciated that this extends to other types of social networking content items described herein, of which news stories are just one example.

In one embodiment, the content item selector 375 selects content items successively, and for each new content item selected, the content item selector 375 considers the relatedness of the new content item with one or more of the previously selected content items. For example, if the content item selector 375 is to select a news story for the information window, the content item selector 375 may first check 520 the ads currently selected for inclusion in the information window. If there are no ads selected yet, the content item selector 375 may select any news story relating to the user. If there are ads selected, the content item selector 375 may check 530 the content items store 175 for news stories for the user that are related to ads that have already been selected. If there are related news stories, the social networking system can select 540 the related news story. Instead of randomly selecting a news story for the user that might have normally been picked, the algorithm applied by the content item selector 375 selects 540 a story related to one of the ads to be included the window.

Conversely, if the content item selector 375 is to select an advertisement, the content item selector 375 can perform the same steps 520, 530, 540 as above, but in this case the content item selector 375 is selecting an ad based on a news story (or other social networking content item). The content item selector 375 may check 525 the news stories that have been selected in the information window, and if there are no news stories selected, the content item selector 375 may select any ad relating to the user. If there are news stories selected, the content item selector 375 may then check 535 the content items store 175 for ads for the user that are related to those news stories. If there are related ads, the content item selector 375 may select 545 the related ads.

In another embodiment, the content item selector 375 selects a plurality of related advertisements and social networking content items at the same time. In this case, the content item selector 375 checks 550 the content item store 175 for the existence and availability of both types of content items. The content item selector 375 then selects 555 a plurality of the advertisements and social networking content items that are related (e.g., in pairs or in groups of related content items). For example, the social networking system may select 555 an advertisement selling a particular product along with a news story about one of the user's connections who recently became a fan of an entity in the social networking system associated with that product.

The content item selector 375 can measure the relatedness of two content items using a variety of techniques, and which technique may depend on the type of content item. In one example, the content items include textual content (e.g., words in an advertisement, the title of a group or event, or portions of a news story). In such an example, two content items may be related if they contain the same words. In another example, content items may be associated with metadata about the content items (e.g., user-provided tag words for an image or video), and this metadata may also be compared to determine whether two content items are related. Content items may also be related based on other attributes, such as their source (e.g., an image posted by another user is related to a news story that mentions the same user). The relatedness may also be based on category information about the content items (e.g., an ad for a concert and a video clip containing a song may be considered in the same category, “music”). The relatedness may be discrete (i.e., related or not related), as in the previous examples, or the measure of relatedness may be continuous. For example, various algorithms could be used to score the relatedness of two content items, based on the similarity of their various attributes.

In each of the cases above, if there are no content items directly related to other items to be included in the window, the content item selector 375 may select distantly related items. In some embodiments, the content item selector 375 may notify the content server 380 to generate a content item on some topic that is related to one of the items in the window (e.g., as shown in FIG. 8, describing content item generation). The content item selector 375 may also select one or multiple content items to include on the display. Once the selection 540, 545, 555 is made, the selected content items can be included 560 on the display, and the display with items can be provided 565 to the user.

### Selecting Content Items Based on Main Portion of Display

FIG. 6 illustrates a content item selection process, in which the content items are selected for a supplemental portion of the display based on the content in a main portion of the display that the user is currently requesting or viewing. Similar to FIG. 5, the method includes receiving 605 from a user a request for information from the social networking system. In response to the user request, the social networking system generates 610 the main portion of the display, which may include a user interface for the user to interact with the social networking system. The display further includes a supplemental portion, such as the information window described above. The supplemental portion of the display is reserved fro inclusion of one or more content items selected for the display. The content item selector 375 thus begins a process of selecting content items, such as news stories, to be added to the supplemental portion of the display.

In one embodiment, the information in the main portion of the display is parsed 620 or otherwise analyzed. The parsing may result in words that are located in the textual content of the main portion. The parsing may also obtain metadata that is not displayed in the main portion (such as html tags) and other information that could result from processing content on the main portion (e.g., the identity or other metadata associated with a video clip, which is identified using a fingerprinting algorithm). Once the content of the main portion of the display is parsed or otherwise analyzed, the content item selector 375 selects 630 content items based on their relatedness to the information in the main portion. As explained above, the measure of relatedness may be determined according to any number of techniques, which may compare attributes of the content in the main portion of the display with available content items to select one or more content items to include in the supplemental portion of the display. Once the content items are selected, they are included 630 to the display in the supplemental portion, and the display is provided 640 to the user.

In one example, if the user has requested a page that includes the profile of a connection having photos of the connection's new baby, a new story selected for the information window might be a story about another connection who posted baby photos, a connection who just had a baby, a connection who became a fan of a baby product, etc. In this manner, the page provided to the user will include a number of items on the same topic. The user may be more likely to click on the news stories in the list/window because they are related to the topic he is viewing on the page he requested. The selected news items may also include advertisements. Continuing the above example, since the user is viewing a friend's baby pictures, an advertisement for a baby gift may be selected and added to the display.

### Example Display

FIG. 7 is an illustration of an example display (e.g., a web page) that might be provided to a user of the social networking system. The example illustrates a profile page for a user (in this example, Bob Jensen) of a social networking system, which provides a photo of the user (in this case, a “No Photo Available” photo), information about the user (his relationship status and school), comments from the user's connections, and recent activity information for the user. The user's page also includes a list of content items (in this example, advertisements and news stories), which are located in an information window 103 that acts as a supplemental portion for the main display page.

In an embodiment of the invention, a user who is a connection of Bob Jensen has requested Bob Jensen's page. As explained above, the page requested will be generated for the viewing user, and certain content items can be included in the information window 103. If a different user requests to view Bob's page, a different collection of content items can be selected for that different user. In FIG. 7, the content items have been selected using the embodiments of the invention described above. For example, the three items 701, 702, 703 are related to the United States in the window. Item 703 is a news story that provides “Photos of trip across US” which was provided by Fred Thompson, who may be a connection of the viewing user as well. Item 702 is an ad for “$39 Flights across the US.” Item 701 is a news story (or could be a social ad, if sponsored) about the USA for which Jim Fredericks became a fan, and the story offers to the viewing user to “Become a Fan,” too. The content item selector 375 has thus selected three content items that are related (e.g., according to the process of FIG. 5), encouraging the chances that the viewing user will interact with one or more of these items.

The fourth item 704 is a news story about Jan Edwards, a connection of the viewing user, and who is attending law school. The selector 375 has selected item 704 according to the process of FIG. 6. This item is not related by topic to the other content items, but is related to the page the viewing user has requested (Bob Jensen's profile) since Bob's profile not only indicates that he is “Attending Law School” in the section 705 providing Bob's personal information, but it also includes a comment from a connection in the comments section 706 about how law school is going. If the viewing user is also attending law school or is a lawyer, which information the social networking system may track, this content item about Jan Edwards can be even more likely to be selected by the selector 375, since it represents an overlap between the viewing user and Bob (e.g., the study or practice of law).

Any combination of the methods of FIGS. 5 and 6 can be used, as well. For example, an item might be selected that is both related to other items in the information window and is also related to the page currently being viewed by the user.

### Content Item Generation Process

FIG. 8 illustrates a process by which content items are generated, according to one embodiment. In this embodiment, the content server 380 receives 800 a request to generate content items. The server 380 queries 805 the action log 365 for actions relating to a user (e.g., actions of connections of a user). Connections between users are provided in the profiles of these users stored in the user profile store 305. The action log 365 returns 810 a list of different actions relating to the user. The content server 380 then generates 815 content items based on those actions, and sends 820 these to the content items store 175 for storage. In some embodiments, the server 380 selects the most relevant actions of connections of the user about which to generate 815 items. For example, the server 380 can select the most recent actions, the actions of connections most closely related to the user or with whom the user interacts regularly, and so forth. In one embodiment, the server 380 generates 815 news stories about these actions (e.g., a news story of a connection that just got married). Advertisements of products may or may not be related to user actions, and so they may be generated by the content server 380, but they also may be created by advertisers or other entities and then stored in the content item store 175. The items can be generated 815 in real-time (e.g., when a user requests information or a particular web page) or in advance for users (e.g., and stored for when the user requests a page). These stored items may have to be updated regularly if a user has not logged on or requested information for a while, to avoid the items from becoming stale.

### Feedback Collection and Usage Process

FIG. 9 illustrates a process by which feedback is collected from users and is used in selecting content items, according to one embodiment. The display server 350 receives explicit feedback when a user rates content items provided. For example, returning to FIG. 7, the ad about the plane flights across the U.S. provides “thumbs up” or “thumbs down” links that allow the user to rate the ad. Other rating systems are also possible (e.g., points, stars, etc.), and the user can in some cases provide comments. The explicit feedback is sent 905 for storage by the display server 350 to feedback store 315.

In some embodiments, implicit feedback can also be collected. The display server 350 can receive 915 user actions regarding the content items provided. For example, the user might click on or otherwise interact with the content item, follow a link to additional information about an item, spend a certain amount of time on this additional information, etc. These types of actions provide information about what a user thinks of the content items provided. The display server 350 can send 920 any actions taken regarding content items to the action logger 360. If the logger 360 determines 925 that the actions provide useful feedback from the user, the logger 360 can send 930 the feedback to the feedback store 315, which can then store 935 this implicit feedback.

The remaining steps illustrate how stored feedback is used to select content items. When the display server 350 has indicated that certain information (e.g. a particular web page) has been requested 940 by a user and the content server 380 requests 945 content items for a display from the selector 375, the selector 375 can query 950 for feedback from the feedback store 315. The store 315 returns any feedback available from the user (e.g., ratings or actions of a user regarding prior content items provided). The content item selector 375 then applies this feedback in selecting 960 content items. For example, if the user gives poor ratings to all travel ads provided, the selector 375 can avoid travel ads for that user. If the user interacts only with social ads and not other ads, the selector 375 can focus on social ads. The feedback can be accumulated in the store 315 and filtered in a variety of ways to acquire trends for a given user, and the selector 375 can apply this information in a variety of ways to select 960 items.

In one embodiment, the processes described above are applied across multiple users. In this case, the selector 375 does not select items by the user, but instead selects items across groups of users. For example, if ad/news story pairs or groups can be reused across multiple users of the same social networking system. If multiple users are connections with Bob Jensen of FIG. 7, the same news story/ad pairs or groups can be shown to his other connections, where relevant.

### Optimization for Mixing Different Types of Content Items

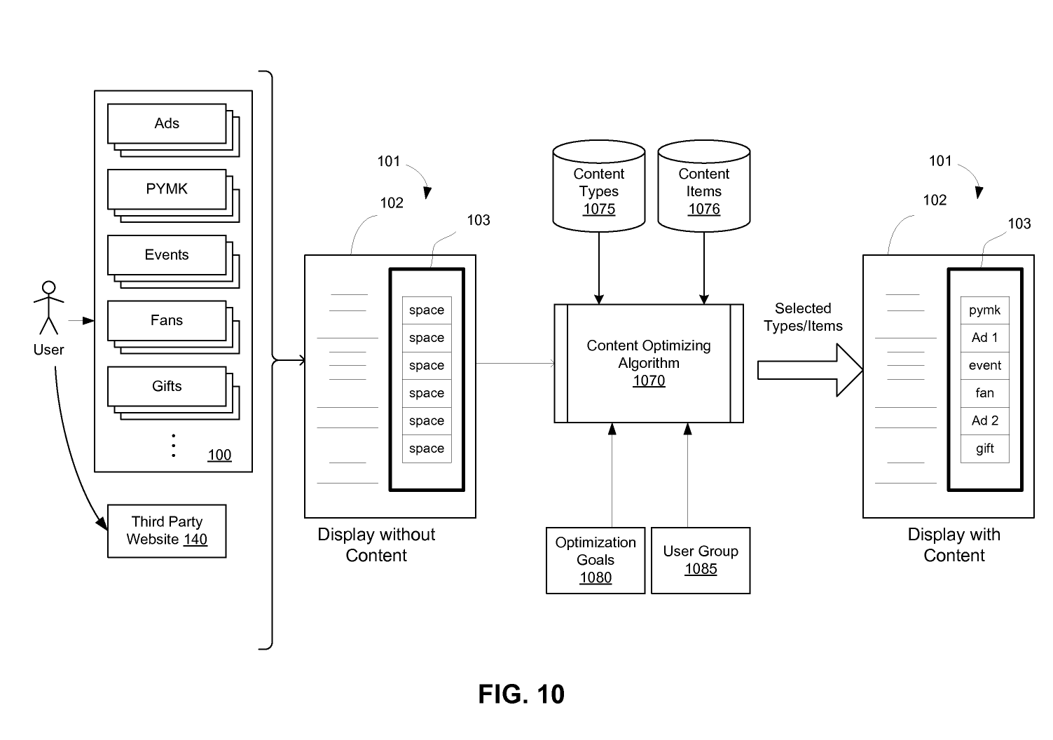

FIG. 10 illustrates a social networking system 100 with which the user can interact. The system of FIG. 10 includes all of the features and explanations associated with the system 100 and third party website 140 of FIG. 1, so those descriptions are not repeated here. FIG. 10 illustrates a process in which content is mixed and targeted to the user for presentation to the user. In FIG. 10, the process includes a display 101 having an information window 103 and a main portion 102, and so includes all of the features of the display/page 101 in FIG. 1. The display without content shows a number of available spaces into which different types of content items can be included.

The content optimizing algorithm 1070 is used to determine the appropriate mixture or ratio of different types of content to include in the available spaces of the window 103 for a given user. A content type database 1075 provides the different types of content used by the optimizing algorithm 1070 for the information window 103 for a user. A content item database 1076 provides the particular content items (of the different types) for a user. The content types can include any of the types described above, such as PYMK, events, gifts, photos, fans, ads, social ads, applications, suggestions, requests, invitations, videos, links, third party content external to the social networking system, and so forth. The content items can include specific instances of those content types for a given user, such as a PYMK item for a first user that suggests a second user to be a person the first user might know.

The algorithm 1070 receives a request for information for a given user, and receives or determines input parameters for that user (e.g., the user group(s) to which the user and optimization goal(s) for that group). The algorithm 1070 then outputs content items for display in the information window to that user. Instead of randomly selecting a content type for a user or selecting based on availability, the algorithm 1070 instead allocates the available spaces of the information window to different content types based on ability of the types to promote the certain optimization goals for a user group. The mixture of the types allocated can vary with different user groups and optimization goals. In one embodiment, the ability of the types to promote certain goals is determined by monitoring the results of presenting different types to users of different groups over a period of time and determining which types of content promote certain optimization goals more effectively than other types. The algorithm 1070 may score each of the types of content based on ability of the types to achieve optimization goals 1080 for different user groups 1085, and the scores can be applied for allocating the types of content to available spaces of information windows for users. The scoring is described in more detail below regarding FIG. 12.

The optimization goals 1080 may include any type of goal associated with presenting content to a user in the window 103, such as monetization, user sharing, user engagement, user communication or network growth, etc. For example, the goal 1080 for a new user of the social networking system 100 may be to encourage growth of a user's social networking system. In this case, the optimization goal 1080 is increased user communication. The algorithm is more likely to select more content types associated with encouraging the user to link to more connections, such as PYMK, invite new connections, connection suggestions, and so forth. In another example, for a user who already has many connections, but does not interact with these connections much, the goal 1080 may be to increase user sharing. In this case, the algorithm is more likely to select more content types associated with encouraging the user to interact with other users, such as events, gifts, photos, etc. In another example, for a user who has a large network of connections and interacts regularly, the goal 1080 may be to increase monetization associated with this user. The algorithm is more likely to select more paid advertisements through which revenue may be made upon user interaction with the ads. Similarly, for a user who has connections and interacts with them, the goal 1080 could be to increase the user's engagement with the social networking system 100, including encouraging the user to post information and photos about himself, to join fan clubs, to utilize applications or play games on the system 100, etc. In this case, the algorithm may be more likely to select more content types associated with encouraging the user to engage with the system 100, such as providing suggestions to play applications or utilize certain features of the system 100 etc.

The optimization goals 1080 may differ for different user groups 1085, and they may be set for each user specifically or set globally for all users of the social networking system. The examples above illustrate a few situations in which the goals 180 may be different based on user type/account usage (e.g., a new user, a user who does not interact much, or a user who has many connections/interacts a lot). The users may also be grouped according to social networking system groups designated by the system 100 (e.g., all supporters of a particular political cause, the fan club for a particular band, etc.) or to user preferences (e.g., all users who have indicated an interest in cooking in their profiles). The user groups may further include groups formed according to the gender or age of the users, geographic location, demographic, user preferences, user profile information, race, ethnicity, account usage or usage history, length of time using the social networking system 100, engagement level, the user's network, among others. For example, female users might be known to be more likely to participate in user sharing (e.g., gift giving, events, etc.) than male users. The goal for male users might be to provide more user sharing content to get the male users involved in interacting (or to provide different types of user sharing content that male users tend to prefer). As another example, the goals for users of a particular geographic location might be different from other locations. If users in Sweden are known not to form many connections, the goal for a user from Sweden may be to increase user communication (e.g., provide more PYMK or invite connections content types).

The goals 1080 may also change over time for a user group 1085. For example, once the Swedish users have begun to form lots of connections, the goal 1080 might then be to focus on monetization and providing more ads to those users to increase revenue. The user groups 1085 and goals 1080 are discussed in more detail below.

The algorithm 1070 receives the parameters (e.g., the user group 1085 and the optimization goal(s) 1080) for a user requesting information (e.g., a display including an information window). Based on the scores for the different content types of database 1075 that indicate the effectiveness in promoting certain goals, the algorithm 1070 may select the types of content or the ratio of types for the information window 103 to be presented to the user. In the embodiment of FIG. 10, to fill the six spaces of the window 103, the algorithm 1070 selected 2 ads, 1 event, 1 fan, 1 PYMK, and 1 gift. In another example, the algorithm 1070 could allocate 50% of the available spaces to PYMK item types, 25% to ad item types, and 25% photo item types.

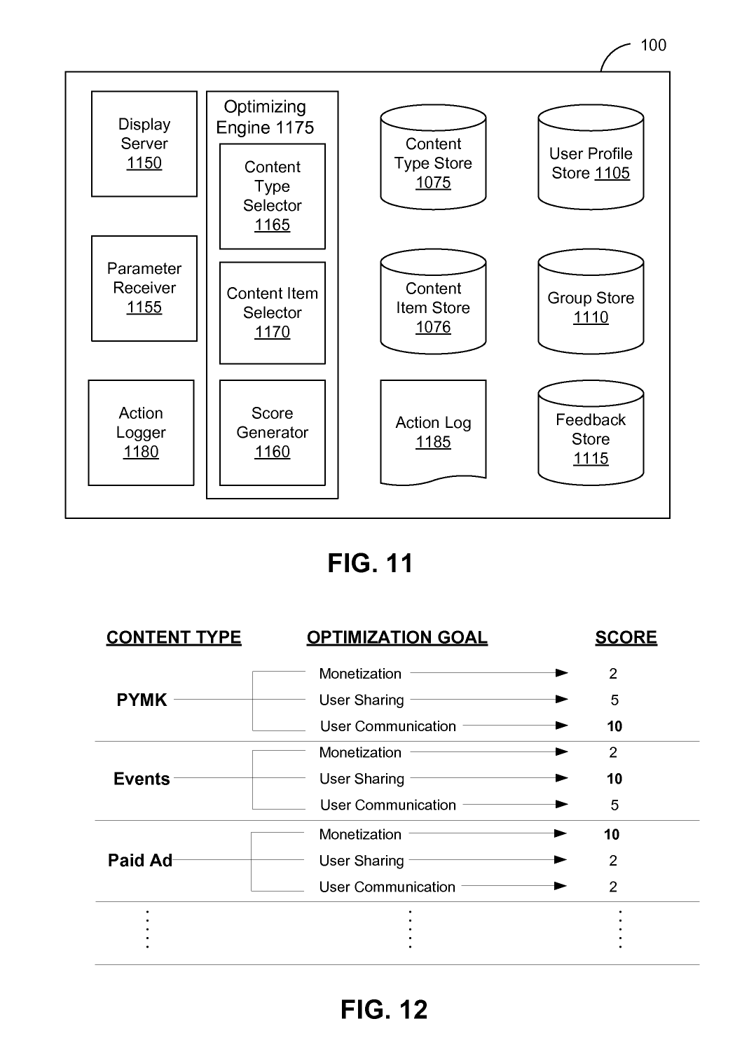

The algorithm 1070 further targets the information window content to a particular user by selecting the content items of the allocated types to fill the available spaces. The content items are selected from the items stored in database 1076 to promote user interaction with the information window 103. In the FIG. 10 example, the algorithm 1070 selects the particular 2 ads to show, the event, fan, PYMK, and gift content items. For example, the algorithm 1070 might select, for a given user, an ad for a vacation package deal, an ad for a new movie, a birthday event for a connection of the user, a fan item that indicates that the user's connection is a fan of the new movie for which the ad was shown, a PYMK for another user with few connections, and a suggestion to send a birthday gift to the connection having the birthday event. Selection of content items is described in more detail below regarding FIGS. 11-14.

Once the algorithm 1070 has selected the appropriate content items to fill the spaces of the information window 103, the display 101 with content items is presented to the user. The content may be presented to the user while he is reviewing any page associated with the social networking system 100 (e.g., the user's own profile or newsfeed, other users' profiles, group profiles, etc.), while the user is using a third party website, etc. The display may be provided as a web page to a user on a website, but may also be provided in an electronic message sent to a client device 210 (e.g., e-mail, text message, etc.), provided as a GUI, and so forth.

The embodiment of the system environment illustrated in FIG. 2 may apply to the FIG. 10 embodiment, too. FIG. 11 is an example block diagram of a social networking system 100. The social networking system 100 includes a display server 1150, a parameter receiver 1155, an optimizing engine 1175 (including a score generator 1160, a content type selector 1165, and a content item selector 1170), an action logger 1180, an action log 1185, a user profile store 1105, a group store 1110, a feedback store 1115, a content type store 1075, and a content item store 1076. In other embodiments, the social networking system 100 may include additional, fewer, or different modules for various applications.

The display server 1150 links the social networking system 100 via the network 220 to one or more client devices 210, as well as to one or more third party websites 140. The display server 1150 may include a mail server or other messaging functionality for receiving and routing messages between the social networking system 100 and the client devices 210 or third party websites 140. The messages can be instant messages, queued messages (e.g., email), text and SMS messages, or any other suitable messaging technique. The display server 1150 can maintain the user profiles for a number of users.

The display server 1150 receives a request for information to be provided or rendered for a user (e.g., the user is navigating to his own profile page) or when content types otherwise need to be determined, and the display server 1150 can communicate this to the parameter receiver 1155 for determining the parameters for the content type selection. In one embodiment, the display server 1150 generates the display to which the content items will be added. In some embodiments, the display server 1150 makes a request for content items to be added to a display each time a display is presented (so the content type/item selection occurs in real time, as a user navigates through the system 100). In other embodiments, the display server 1150 makes a request for content items without having a particular display on which to immediately post those items. In these embodiments, the selected content types/items are stored for later presentation to the users.

The parameter receiver 1155 determines parameters to be input into the content optimizing algorithm 1070. The receiver 1155 determines a first parameter, which is a user group 1085 for one or more of the users. The receiver 1155 also determines a second parameter, which includes one or more optimization goals 1080 for interaction of the user group 1085 with the information window 103. The parameter receiver 1155 determines these parameters, in one embodiment, by gathering information about a user to whom content is to be provided from the user profile store 1105 (e.g., user's preferences, gender, geographic location, etc.). In some embodiments, one or both of these parameters for the user are determined in advance by the parameter receiver 1155 and retrieved when needed.

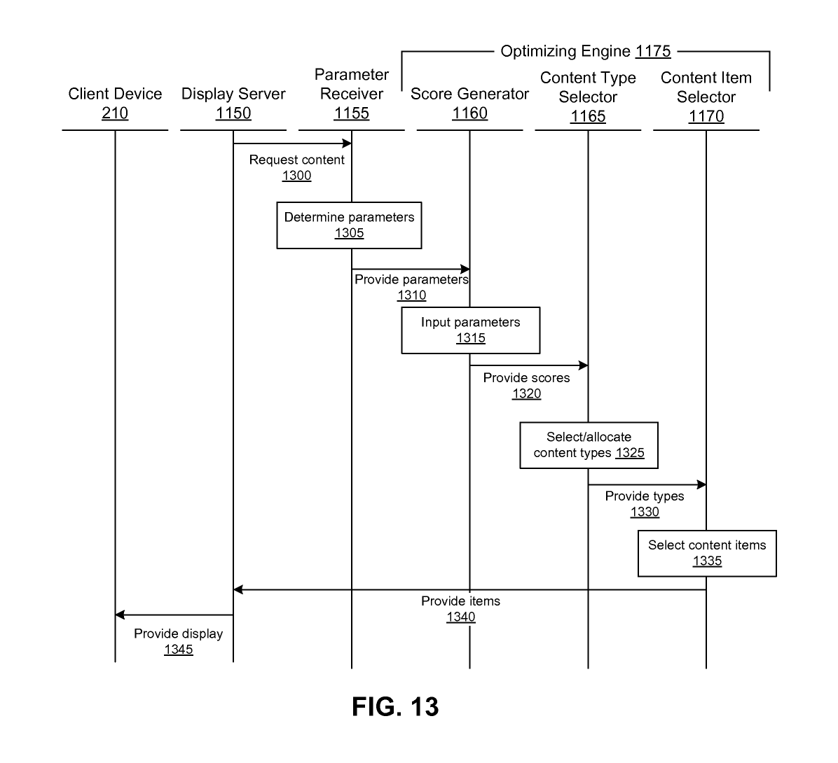

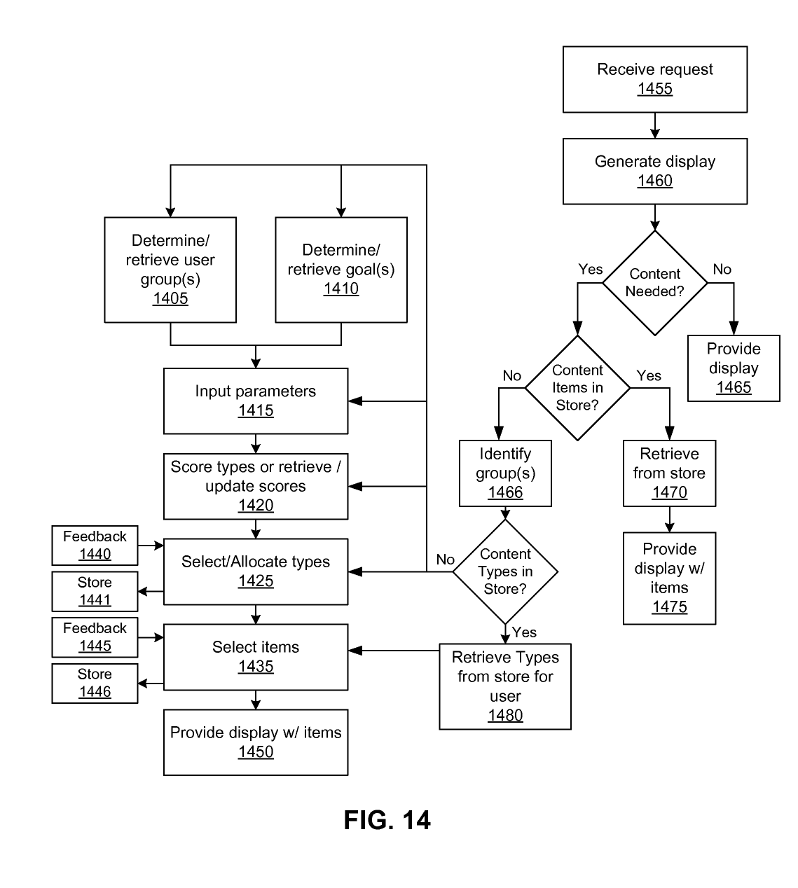

The parameter receiver 1155 can also obtain information about that user's actions from the action log 1185 for determining the parameters. This action log 1185 is structured in the same manner as action log 365 of FIG. 3, so the description of action log 365 above applies here too. The action log 1185 can store any action a user takes on an object associated with the system 100 or actions relating to other users (e.g., typical account usage of a user, actions indicating user preferences or user type, and so forth). The receiver 1155 can also gather information about groups joined by the user from the group store 1110 (e.g., group supporting a political or social cause, musical band fan site, local city network, etc.). All of this information can then be used by the receiver 1155 in classifying users into user groups 1085 or determining goals 1080. User groups 1085 and optimization goals 1080 are discussed in more detail regarding FIGS. 13 and 14 below.

The optimizing engine 1175 inputs the parameters collected by the parameter receiver 1155 into the optimization algorithm 1070 for allocating/selecting content types and selecting content items for the user. The engine 1175 then outputs the selected content items for that user. Thus, the optimized mixture of content items can be provided for that for that user to further optimization goals for the user's group.

In some embodiments, the optimizing engine 1175 includes a score generator 1160 for determining the ability of different content types to promote the one or more optimization goals. The score generator 1160 can monitor the results of presenting content items of allocated types to users of different user groups over a period of time. The score generator 1160 can determine, based on the results, which types of content promote certain optimization goals more effectively than other types. For example, the score generator 1160 might determine, by monitoring over a period of time, that presenting PYMK content types tends to increase communication between users and encourage growth of the social networking system. The score generator 1160 can determine this by comparing groups of users to whom a higher percentage of PYMK items were displayed than were displayed to other groups. The score generator 1160 can determine whether the rate of forming connections with other users or the size of the network increases for the groups of users who viewed more PYMK content types. The score generator 1160 can then score the types of content based on the ability of the types to achieve certain optimization goals.

FIG. 12 illustrates one example of the scoring performed by the score generator 1160, according to an embodiment of the invention. In this example, each of the content types is scored based on its ability to further each optimization goal. Three different optimization goals are scored in FIG. 12 (monetization, user sharing, and user communication), though other goals can be included and scored too. In the example, the scoring range is from 1 to 10, though other ranges can be used (e.g., 1 to 50, 1 to 100, etc.) and other scoring/weighting systems can also be used. In the example, the content type, “PYMK,” is rated very high for the user communication goal, since PYMK promotes creation of more connections between users when a user selects a PYMK content type from the information window 103. The content type, “events,” is rated very high for user sharing, since event items encourage users to share and interact with other users using the system 100. The content type, “paid ad,” is rated very high for monetization, since providing ads to users that the users can select and interact with can allow the system 100 to generate money. Other content types can be scored, as well.

The scores illustrated in FIG. 12 may be the same across the different user groups 1085 or they can vary for different user groups 1085. So, each type can be scored for its ability to promote each goal across all user groups, and/or each type can be separately scored for promoting goals for each group. For example, it could be the case that male users tend not to interact much with event content items. So, even though event items tend generally to promote user sharing across user groups, the event item does not score a 10 in user sharing for male user groups, but only scores a 4 and maybe only a 1 in both user communication and monetization. However, male users may tend to interact more with fan content items, and so those items might score higher on user sharing for the male user group. How a content type should be scored can be determined by reviewing information in, e.g., the action log 1185, the user profile store 1105, and the group store 1110. For example, the actions stored in the action log 1185 could be filtered to determine items with which male users tend to interact.

In addition, scores may be updated occasionally or regularly. Scores for different goals may change over a period of time as more or different user groups are identified, new content types become available, new goals are set or previous goals are modified, more information is gathered about current user groups, goals, content types, content items, and so forth. The scores and/or the scoring system may be adjusted by an administrator to address different goals for the social networking system 100.

The content type selector 1165 may select, based on the scores provided by the score generator 1160, the types of content and allocate the content types for the information window. The types selected/allocated can vary by user group 1085 and goals 1080. For example, for a group of male users between ages 20 and 25, where the goal is primarily to encourage user sharing and secondarily to encourage user network growth, the selector 1165 may review the content type scores for those goals for that user group. The selector 1165 may select the types having the top four scores for sharing (e.g., events, gifts, fans, and applications), and could select the type having the top score for network growth (e.g., PYMK). Each time a male user between age 20-25 requests information, he could be provided with those five types. These types might all be provided on one display, or over a number of displays/pages. The displays could be arranged so that the user receives other content types too, but receives a higher concentration of the selected types. In another example, the selector 1165 could select many types having high scores in user sharing and also some having high scores for network growth, and could provide only or predominantly these types to the user group over time.

The content type selector 1165 may also be configured to allocate a ratio or percentage of the available spaces to be filled with different content types. In one embodiment, the selector 1165 allocates a certain percentage of the spaces for a user group to a specific content type (e.g., 5% of the spaces for users in Germany to event types). In another embodiment, the selector 1165 allocates a specified percentage of the available spaces to a particular content type for all users having less than a specified number of connections to other users in the social networking system. For example, users falling in a user group of “users who have less than X number of connections” could have 50% of their spaces filled by types known to promote network growth (e.g., PYMK, connection requests or invitations, etc.). As another example, users falling in a user group of “users who have interacted with another user fewer than X number of times in the past week” could have 75% of their spaces filled by types determined to encourage interaction or information sharing between users. The selector 1165 could also allocate a certain percentage of the available spaces to one or more types, and then select the remaining content types randomly or based on availability. Thus, the content types can be selected in a number of different manners, and the examples provided above are not limiting but are just a few possibilities.

In another embodiment, a user can be a user of multiple groups (e.g., a “males between 20-25” group and a “San Francisco resident” group). Thus, a given user may have content types scored and selected for him based on his membership to multiple groups. For example, user can be presented with a display having content types for one group and then a display for the next group, the user can be presented with displays having a mixture of types for both groups, the user can be presented with displays including only or predominantly content types associated with a primary or more important group, and so forth.

In some embodiments, the selector 1165 selects a certain number of types to fill a certain number of available locations on a display. In other embodiments, the selector 1165 selects various content types that are appropriate for the user or for the user group 1085, and there may be fewer or more types selected than are open locations on the display. If there are fewer types selected, the remaining locations can be filled randomly or can be left empty (or the display can be otherwise rearranged to show only the few types selected). If there are more types selected, the display can be arranged to hold more types, or the additional types selected can be provided on later displays (e.g., as the user continues to navigate through the system).

The timing of selection performed by the selector 1165 varies in different embodiments. In one embodiment, the selector 1165 selects one or more of the content types in real-time, as members of different user groups navigate through the system 100. In another embodiment, the selector 1165 selects one or more of the content types in advance for a given user group, and those selected types are stored and used when a member of the user group is logged on to his account or requests information. In some embodiments, a selection of a particular ratio of content types is performed across multiple users of a user group 1085, so that multiple users will be provided with the same mixture of types selected for their user group 1085. In other embodiments, the selection varies by member or by subsets of members of a user group 1085, so that not all users of a group 1085 will be provided with the same mixture of types.

The content item selector 1170 selects content items of each of the types of content selected by the content type selector 1165. The content items are selected to promote user interaction with the information window 103. In one embodiment, the content items selected are specific to the particular user to whom they will be presented. In other words, as explained above, a particular mixture of different content types may have been selected for a given user group (e.g., male users between ages 15 and 20). So, for a user within the group, the selector 1170 can select particular items, of those types, for that user. For example, where one of the types of content selected by selector 1165 for a given user group (e.g., male users between ages 15 and 20) is a PYMK type, an example of the content item selected by selector 1170 for user Tom Edwards who is a 16-year old male could be the following: “You and Bob Smith both go to Central High. Add Bob as a connection.” In one embodiment, one or more items are selected by selector 1170 on-the-fly, as a user has requested information to be rendered. In another embodiment, one or more content items are selected in advance and stored for one or more users to be provided to the users the next time they log into their accounts.

In some embodiments, the content item selector 1170 varies the content items selected for the display (e.g., in the information window 103) based on feedback received from the feedback store 1115. The feedback can be input as a third parameter for the optimizing engine 1175. The description of feedback stored in feedback store 315 applies to feedback store 1115, as well. The selector 1170 can use this feedback in the future for providing better, more relevant content items to that user (e.g., items on a different subject, items that are more closely related, etc.). In some embodiments, the feedback provided by users is also used by the content type selector 1165 in optimizing the mixture of types selected. The types selected for a user group 1085 to which a user belongs can be varied based on that user's feedback or based on overall feedback from users of the group. The feedback for users of a group 1085 can be stored over time in feedback store 1115 and can be filtered in various manners to optimize the mixture of types provided to the users of the group 1085.

The display server 1150 provides, to the user requesting information, the display with the information window having the selected content items of the selected content types. In some embodiments, the display server 1150 determines in what order to provide the items. For example, the server 1150 can place more relevant items at the top of the window, or in some other prominent presentation on the display. In other embodiments, this ordering is determined by the optimizing engine 1175. In embodiments in which the multiple items were selected (e.g., more items than can be presented on one page), the display server 1150 or optimizing engine 1175 can determine which items to present on the current display, and what items to present on additional pages to which the user navigates. In some embodiments, how to order items on a display or across multiple displays is determined over a period of time by collecting feedback from users indicating what types of presentation mechanisms are the most successful in promoting user interaction with the information window.

In some embodiments, the system 100 includes an action logger 1180 that functions in generally the same manner as action logger 360. The logger 1180 is capable of receiving communications from the display server 1150 about user actions on and/or off the social networking system 100. The action logger 1180 populates the action log 1185 with information about these user actions tracked. There are various different types of actions that can be logged by logger 1180, as explained above regarding logger 360 in FIG. 3.

### Process for Selecting an Optimized Mixture of Types of Content Items

FIG. 13 illustrates the overall content type/item selection process, according to an embodiment of the invention. In this embodiment, the method includes a request 1300 for content from the display server 1150 for a user. In some embodiments, this request comes from the display server 1150 because a client device 210 has requested information to be rendered. As explained above, in these embodiments, the process can be performed in real time, as users make requests. In other embodiments, the request comes from the display server 1150 because the server 1150 has determined it is time to perform the selection process. For example, the content type store 1075 or content item store 1076 could be running low or the content may need updating. In these embodiments, one or both of the content type or item selection can be performed or partially performed in advance, before a user has requested information, and the stores 1075/1076 are populated with types/items already selected for user groups/users.

When the display server 1150 has requested 1300 content for a user, the parameter receiver 1155 can determine 1305 parameters (or retrieve previously determined parameters), including grouping the user into one or more user groups 1085. The receiver 1155 can determine or retrieve information regarding a user's gender, geographic location, age, race, ethnicity, and other information from the user profile store 1105 for assigning the user to a group 1085. For example, all female users could form one group, and all users in California could form another group. Similarly, groups can include all users in the Bay Area, all users between age 20 and 30, all Latino users in the city of San Jose, all male users in San Francisco between ages 15 to 20, and so forth. The receiver 1155 can also obtain information from the action log 1185 about user actions when determining the groupings (e.g., how often the user logs on to his account, how he uses his account, and other relevant actions). Further, the social networking groups that a user has joined (e.g., fan clubs) stored in group 1110 store can also be used by the receiver 1155 in setting user groups (e.g., a group of all members of a particular fan club). In some embodiments, the grouping has been done in advance, and so the determining 1305 step includes retrieving the groupings or possibly updating the groupings.

The receiver 1155 can also determine 1305 the optimization goals 1080 (or retrieve previously determined goals) for the user group 1085 to which the user is determined to below. The receiver 1155 can obtain information from the action log 1185, the user profile store 1105, and/or the group store 1110 to determine the goals 1080. For example, the action log 1185 might be filtered for actions performed by users from Cincinnati, Ohio to determine how those users tend to use their accounts (e.g., whether they frequently interact with other users, whether the log on regularly, whether they click on ads often, etc.). If the filtering of action information in the log 1185 shows that Cincinnati users tend to rarely interact with their connections in a social networking system, the receiver 1155 can determine that the goal for those users is to promote more user sharing. The receiver 1155 can determine one goal for each group 1085 or multiple goals for each group 1085. Certain goals might be rated as more important than others. For example, another goal for the Cincinnati users might be to focus on monetization, but the user sharing goal might be the main interest. In this case, the content types selected for the users might include mostly content types expected to increase sharing, but the users might also be shown a few sponsored ads too, either on the current page, on later pages, at some later date, etc. In some embodiments, the goals have been determined in advance for the user groups 1085, and so the determining 1305 step includes retrieving the goals or possibly updating the goals.

The parameter receiver 1155 provides 1310 the parameters determined 1305 optimizing engine 1175 inputs 1315 the parameters for the user into the content optimization algorithm 1070. The parameters 1310 can be provided to the score generator 1160 for inputting 1315 and scoring the types of content, as explained above. In some embodiments, the content types have been scored in advance, and the generator 1160 might just retrieve these scores, and/or might update the scores where needed. The generator 1160 provides 1320 the scores to the content type selector 1165, which selects/allocates 1325 the types for the information window for the users. The selector 1165 provides 1330 the types to the content item selector 1170. One or more of the types selected can be stored in the content type store 1075 until later needed, at which point the content type selector 1165 can retrieve these from the content type store 1075 and provide these types to the content item selector 1170. The content item selector 1170 selects 1335 the content items of each of the selected types of content for the window. The selector 1170 provides 1340 the selected items to the display server 1150.

In some embodiments, the display server 1150 includes the selected items in the display generated for the user. The server thus provides 1345, to the user, the display with the information window having the selected content items of the selected content types. In some embodiments, instead of generating a display upon selection of the items, the selected items are instead stored in the content items store 1076 for a given user. When the user for whom the content items are stored requests information to be rendered (e.g., a web page), the display server 1150 can then generate the page, query the store 1076 for content items, and provide 1345 the display with items to the user.

FIG. 14 illustrates a content type/item selection process showing the offline process when selection is performed in advance and showing the online process in which selection is performed in response to a user's request (the method can also include a combination of the two). In the offline selection embodiment, the system decides and requests that content types/items be selected. For example, the content type/item selection can occur at regular time intervals (e.g., every minute, every 30 minutes, every hour, once a day/week/month, etc.), when a user logs onto his account, when the content type/item stores 1075, 1076 are determined to be low in types/items for a user or user group 1085, and so forth. The frequency with which types/items are selected can vary for different users/groups. For example, types/items may be selected more frequently for users/groups that use the system 100 regularly than for users/groups who only use the system 100 once in a while.

The social networking system determines 1405 the user groups and determines 1410 the optimization goals (or retrieves one or both of these from storage if determined in advance), as explained above. The parameters determined 1405, 1410 are input 1415 into the algorithm 1070 and the content types are scored 1420 (or pre-determined scores are retrieved/updated), as also explained above. Based on the scoring, the content types are selected 1425 for the information window. In one embodiment, the selected types are stored 1441 in the content type store 1075 for the particular user/user group for which they were selected (e.g., by being linked to an ID number or other identifier for the user/group) until they are needed

In one embodiment, feedback 1430 is provided that can vary the types of content types selected 1425. The information in the feedback store 1115 can be filtered to retrieve feedback 1430 for the members of the user group 1085 for which content types are being selected 1425 (e.g., explicit or implicit feedback of users on the content items provided to those users). For example, Bob Smith can provide negative feedback on all of the items of the PYMK type provided to him by giving them a negative rating or by never clicking on these items. This feedback can be incorporated into the store 1115 along with feedback from other users from Bob's group (e.g., male users age 15-20). If many of the users of this group are giving similar feedback on the PYMK types of items, then fewer PYMK content types may be provided to this group.

The social networking system selects 1435 content items of each of the selected types of content. In one embodiment, numerous content items are selected for a given user and are stored 1446 the content item store 1076 for the particular user for which they were selected (e.g., by being linked to an ID number or other identifier for the user) until information is requested by the user.

Again, feedback 1445 can be provided, which can vary the items selected. The information in the feedback store 1115 can be filtered to retrieve feedback 1445 for the user on the content items provided to that user. For example, Bob Smith can provide negative feedback on all of the ads provided to him by giving them a negative rating or by never clicking on these items. This feedback can be used to select different types of ads for Bob (e.g., more social ads, and fewer ads for products, or ads on topics that are more of interest to Bob). In some embodiments, the particular item selected of the content type for a given user can be selected using additional factors. For example, instead of randomly selecting an ad for Bob, the ad or other item could be selected based on its relation to other items in the web page Bob is viewing or based on its relation to other items that will be included in the window

All of the above steps can be performed offline to prepare content types and items in advance. At some point later, the selected content items of the selected content types are added to a display for a user, and the display is provided 1450 to the user(s) with the items.

FIG. 14 also illustrates on online embodiment. In this case, the method begins when information is requested. In this embodiment, a request is received 1455 for a user and the system starts the process associated with generating 1460 or rendering a display for the user. If information window content is not needed (e.g., there is no information window, etc.), then the display is provided 1465 to the user. If content is needed, the method includes checking to determine if content items are in the content items store 1076 for the requesting user (e.g., by filtering items in store 1076 based on user ID). If so, one or more of those items can be retrieved 1470 from the store and included in the display provided 1475 to the requesting user. If there are not items in the store for the requesting user, new items can be selected. The method can then include identifying 1466 the user group to which the user belongs, and then checking the content type store 1075 for content types for any user group to which the user belongs. If so, one or more of the types can be retrieved 1480 for the user and content items of those types can be selected 1435 for the user. If there are no content types, then the method can include going through one or more of the above-described steps to select the types.

In some embodiments, the user group 1085 and goals 1085 may need to be first determined 1405, 1410. These parameters can be input 1415, the types scored 1420 (or score retrieved), and the content types can be selected 1425, as described above. However, any one or more of steps 1405, 1410, 1415, and 1420 may have already been performed, so the only step necessary at this point may be the selection step 1425 or some subset of steps 1405 through 1425. Items of the selected types are then selected 1435, and the display with the items is provided 1450 to the requesting user.

Referring back to FIG. 7, this example could also represent an example of the embodiments of FIGS. 10-14. Bob Jensen might have requested his home page, and the additional content items added to Bob's page include the four items on the right of the page. For example, Bob might be a member of a user group 1085 of males between ages 30 and 40 living in Kentucky for which the optimization goal 1080 is to primarily to encourage user sharing, but secondarily to promote monetization. Where the content types of fans, photos, and connections' actions scored high for user sharing, and ads for products scored high for monetization, Bob can be shown one fan type, one ad, one photo type, and one connection update type. The particular items selected for Bob include an item 701 for becoming a fan of the US, an item 702 for flights in the US, an item 703 for photos provided by a connection, and an item 704 for providing an update about a connection attending law school.

Content items can be generated for embodiments of FIGS. 10-14 in a manner similar to that described in FIG. 8, where the display server 1150 generates the items by interacting with the action log 1185 and content item store 1076. Feedback can also be received and applied for embodiments of FIGS. 10-14 in a manner similar to that described in FIG. 9, where the acting parties are the display server 1150 (which can also perform the functions of the content server 380), the action logger 1180, the content item selector 1170 (or content type selector 1165), and the feedback store 1115.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of a social networking website, it will apparent to one of ordinary skill in the art that the invention may be used with any electronic social networking system, even if it is not provided through a website. Any computer-based system that provides social networking functionality can be used in accordance with the present invention even if it relies, for example, on e-mail, instant messaging, or other form of electronic communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

What is claimed is:

1. A computer-implemented method for advertising to a user, the method comprising:
receiving in a social networking system a request for information from a user of the social networking system;
generating a display of information responsive to the request, wherein the display includes a main portion that comprises a user interface for interaction with the social networking system;
selecting one or more advertisements based on a measure of relatedness to the information in the main portion of the display;
adding the selected one or more advertisements to a supplemental portion of the display; and
providing the display to the user, the display including the main portion and the supplemental portion.

2. The method of claim 1, wherein the measure of relatedness is determined by comparing an attribute of a selected advertisement to an attribute of the information in the main portion of the display.

3. The method of claim 1, further comprising:
selecting one or more social networking content items based on a measure of relatedness of the selected social networking content items to the information in the main portion of the display, wherein a social networking content item comprises information about an object or functionality of the social networking system; and
adding the selected one or more social networking content items to the supplemental portion of the display.

4. The method of claim 3, wherein selecting one or more social networking content items is further based on a measure of relatedness of the selected social networking content items to the selected one or more advertisements.

5. The method of claim 1, wherein the display provided to the user is a web page of a social networking website.

6. The method of claim 1, wherein the display provided to the user is a web page outside of the social networking system, and providing the display to the user further comprises syndicating the supplemental portion onto a website outside of the social networking website.

7. The method of claim 1, wherein providing the display to the user comprises sending the display to a mobile device of the user.

8. The method of claim 1, wherein selecting one or more advertisements is further based on a measure of relevance of the selected advertisements to the user.

9. The method of claim 8, wherein the measure of relevance is determined by one or more of:
a history of interactions of the user with a social networking content item,
information stored in a profile associated with the user, and
express feedback about a social networking content item provided by the user.

10. A system for advertising to a user, the system comprising:
a display server configured to receive a request for information from a user of a social networking system and to provide a display to the user, the display including a main portion and a supplemental portion;
a display generator configured to generate the display of information responsive to the request, wherein the main portion of the display comprises a user interface for interaction with the social networking system, the display generator further configured to add one or more advertisements to the supplemental portion of the display; and
a content item selector configured to select one or more advertisements based on a measure of relatedness of the selected advertisements to the information in the main portion of the display, and to provide the selected advertisements to the display generator for addition to the display.

11. The system of claim 10, wherein the content item selector is configured to determine the measure of relatedness by comparing an attribute of a selected advertisement to an attribute of the information in the main portion of the display.

12. The system of claim 11, wherein:
the content item selector is further configured to select one or more social networking content items based on a measure of relatedness of the selected social networking content items to the information in the main portion of the display, wherein a social networking content item comprises information about an object or functionality of the social networking system; and
the display generator is further configured to add the selected one or more social networking content items to the supplemental portion of the display.

13. The system of claim 12, wherein the content item selector is configured to select one or more social networking content items is based on a measure of relatedness of the selected social networking content items to the selected one or more advertisements.

14. The system of claim 10, wherein the display is a web page of a social networking website.

15. The system of claim 10, wherein the display is a web page outside of the social networking system, and display server is configured to provide the display to the user by syndicating the supplemental portion onto a website outside of the social networking website.

16. The system of claim 10, wherein the display server is configured to provide the display to the user by sending the display to a mobile device of the user.

17. The system of claim 10, wherein the content item selector is configured to select one or more advertisements based on a measure of relevance of the selected advertisements to the user.

18. The system of claim 17, wherein the measure of relevance is determined by one or more of:
a history of interactions of the user with a social networking content item,
information stored in a profile associated with the user, and
express feedback about a social networking content item provided by the user.
